(19) United States
(12) Patent Application Publication
(10) Pub. No.: US 2014/0285058 A1
(43) Pub. Date: Sep. 25, 2014

(54) SQUIRREL CAGE ROTOR AND INDIVIDUAL PARTS THEREOF AND METHOD FOR PRODUCING A SQUIRREL CAGE ROTOR

(71) Applicants: Gerhard THUMM, Erbach (DE); Volker VOGGESER, Senden (DE); Michael WOLF, Ulm (DE)

(72) Inventors: Gerhard THUMM, Erbach (DE); Volker VOGGESER, Senden (DE); Michael WOLF, Ulm (DE)

(21) Appl. No.: 14/223,055

(22) Filed: Mar. 24, 2014

(30) Foreign Application Priority Data
Mar. 22, 2013 (DE) 10 2013 005 050.2

(51) Int. Cl. H02K 17/16; H02K 15/00

(52) U.S. Cl. CPC H02K 17/165; H02K 15/0012
USPC 310/211; 29/598

(57) ABSTRACT

The invention comprises a squirrel cage rotor, in particular for use in an asynchronous machine, with a shaft, a laminated rotor core with cage bars and short-circuiting rings arranged within it, at least part of a short-circuiting ring consisting of a disk stack, which is built up in layers from disks with clearances, through which the ends of the cage bars extend out from the laminated rotor core, wherein the disks of a short-circuiting ring have, starting from the lateral surface as the outside face, over the outer circumference at least one bevel or step, which is directed radially inward, and wherein, by their respective bevels or steps, neighboring disks form in the disk stack a slot, in which there is a joining connection, at least in certain portions.

The invention also concerns individual parts of a squirrel cage rotor and also a method for the production thereof.

The invention relates to a squirrel cage rotor and individual parts thereof according to the respective preamble of claims 1, 12 and 13 and to a method for producing a squirrel cage rotor according to the preamble of claim 14.

In the case of known squirrel cage rotors, a laminated rotor core provided with closed slots contains, embedded in the slots, cage bars made of a material with good electrical conduction, the ends of which protrude beyond the end faces of the laminated rotor core and are hard-soldered to compact short-circuiting rings. The ends of the cage bars protrude into machined annular grooves in the short-circuiting rings, which form the bed for the hard solder and are filled with it, resulting in the need for a relatively great amount of hard solder. To prevent the delamination of the laminated rotor core and disturbing vibrations, separate compact end rings are pressed onto the end faces of the laminated rotor core. In order also to prevent an axial displacement of the cage bars in the slots of the laminated rotor core, they are mechanically firmly connected to the laminated rotor core.

The document DE 34 21 537 A1 discloses a squirrel cage rotor with cage winding. The cage winding comprises electrically conducting cage bars, which are arranged in closed slots of a laminated rotor core and protrude beyond its end faces. The protruding ends are connected in a conducting manner to short-circuiting rings of good electrical conduction. In a way corresponding to the laminations of the rotor, the short-circuiting rings are slotted sheet stacks made of a material of good electrical conduction and, as end thrust pieces, are firmly connected to the cage bars, lying in close contact with the laminated rotor core in the closed slots thereof, and with heat transmission over the entire surface area. One particular feature is that the electrically conducting individual sheets for the short-circuiting rings have a greater thickness than the laminations of the rotor, but they are otherwise of the same form and size. In the production of a squirrel cage rotor, the short-circuiting rings and the rotor laminations are assembled in a common stack, fitted with the cage bars pushed in at the end faces and then the ends of the cage bars are hard-soldered to the short-circuiting rings while the entire stack is subjected to axial pressing.

The invention is based on the object of developing the joining connections of a squirrel cage rotor.

The invention is described with respect to a squirrel cage rotor and the individual parts thereof by the features of claims 1, 12 and 13 and with respect to a method for producing a squirrel cage rotor by the features of claim 14. The further, dependent claims concern advantageous forms and developments of the invention.

The invention comprises a squirrel cage rotor, with a shaft, a laminated rotor core with cage bars and short-circuiting rings arranged within it, at least part of a short-circuiting ring consisting of a disk stack, which is built up in layers from disks with clearances, through which the ends of the cage bars extend out from the laminated rotor core, wherein the disks of a short-circuiting ring have, starting from the lateral surface as the outside face, over the outer circumference at least one bevel or step, which is directed radially inward, and wherein, by their respective bevels or steps, neighboring disks form in the disk stack a slot, in which there is a joining connection, at least in certain portions. The squirrel cage rotor is intended in particular for use in an asynchronous machine.

The invention is based here on the consideration that, after the joining operation, the laminated rotor core with the shaft and the short-circuiting rings should provide a compact squirrel cage rotor component. Led through the laminated rotor core and the short-circuiting rings are cage bars, which are connected in an electrically conducting manner to the material of the short-circuiting rings. For this purpose, the cage bars have an overlength with respect to the laminated rotor core, with the result that they protrude into clearances in the short-circuiting rings. The short-circuiting rings are positioned on the shaft on both sides of the laminated rotor core. Each short-circuiting ring consists itself of a disk stack, which is built up from multiple individual disks of the same diameter. The disks themselves have on the disk face as many clearances as cage bars are required for building up a squirrel cage rotor. These individual components, which are initially arranged loosely in relation to one another, must be connected to form a compact squirrel cage rotor. To establish a joining connection, the outside face of the disks is provided with at least one bevel or step, starting from the lateral surface of each short-circuiting ring. If the geometry of a disk is regarded as a cylinder, the lateral surface is the outside enveloping or circumferential surface, that is to say the outermost region of the surface when viewed in the radial direction. The bottom and top faces of the cylinder are then the surfaces perpendicular to its axis of rotation. This has the consequence that, by virtue of the bevel or step, neighboring disks arranged to form a disk stack have a small gap as a slot, along which a joining connection can be established. A slot between the disks extends around the circumference of each disk stack. In a preferred embodiment, the bevels or steps are formed on a disk in such a way that they radially extend approximately as far as the clearances for the cage bars. In this way, a slot which can reach radially as far as the level of the cage bars is formed. In order to connect the individual disks in the disk stack to the cage bar, a joining connection which connects the individual parts to one another both mechanically and electrically is established along this slot. Between the disk faces lying next to one another of neighboring disks, there is only one joining plane.

Alternatively, the bars extending out from the laminated core may also not be exposed in the region of the slot that is formed by bevels or steps. Considered radially, the clearances in the disks are consequently positioned somewhat within the slot of the disks, considered radially inward, but in such a way that the bars nevertheless lie in the region of the melting zone during the welding. Consequently, during the joining, the regions of the bars in the vicinity of a slot are flowed around by a melt produced by means of a laser beam or electron beam and are connected in an electrically conducting manner to the disks. An essential point here is that once again, between the disk faces lying against one another of neighboring disks, there is merely one joining plane.

In other words: in the radial direction, a freely accessible opening consequently extends between neighboring disks as far as the level of the cage bars, in order to be able to join the individual parts to one another both electrically and mechanically. In this way, a sufficient electrical contact for current conduction for the operation of an asynchronous machine is established. The clearances machined in each disk are adapted in form and size to the cage bars, with the result that they can be positioned with little play. The disks of the short-circuiting rings may in this case either represent individual components made of a strip material and closed in a flat form or else be produced as an open disk, similar to a snap ring. The clearances in each disk may for example be eroded, drilled or stamped. It is also conceivable that each individual disk has on the contact face with the neighboring disk a structure which causes a small gap that is advantageous for a joining connection. In this way, a further zone for a joining connection may also be produced radially into the depth beyond the region of the bevel or step.

The particular advantage is that a narrowly restricted, but sufficient joining region in the region of the slots provides sufficient mechanical strength of the component as a whole. Similarly, a satisfactory electrical contact of the cage bars with the short-circuiting rings is also established. Even in the case of joining methods that take place at a relatively high temperature, local heating only occurs in the joining gap between two disks, without the rest of the component, and in particular the laminated rotor core, being thermally affected at the same time. By virtue of their good electrical conductivity, the alloys that are used for short-circuiting rings usually also have sufficient thermal conductivity, whereby the thermal energy introduced during the joining is quickly dissipated by the heat spreading. In this way, the individual disks are joined and firmly connected to one another in the region of the outer circumference. Depending on the joining method, particular care is given to the shape and form of the bevel or step, which ultimately determines the joining gap. For example, on each disk the bevel itself may represent a planar surface, which in the joined state forms a V-shaped slot with a neighboring disk. On the other hand, it is also conceivable that the bevel has a parabolic shape, with the result that a U-shaped slot is produced in the joined state. Depending on the joining method, in this way a geometrically favorable joining connection can be created.

In a preferred configuration of the invention, the bar ends are joined in an electrically conducting manner to the disk stack of a short-circuiting ring. Usually, simply joining the bar ends together in short-circuiting rings leads to an electrical connection that is not sufficient.

The desired electrically conducting connection can be accomplished either by the material of the individual disks being incipiently melted locally for a short time and neighboring disks becoming connected to the material of the bar ends along the joining gap. On the other hand, it is also conceivable that an electrically conducting connection is established by additional material, such as for example hard solder, which is introduced into the slot-shaped region. In the case of such joining connections, the slot formed by the bevels or steps usually reaches somewhat deeper, with the result that during the joining the solder material also reaches the surface of the cage bars. In this case, the slot formed by the bevel or step then reaches radially to such a depth that the entire circumference of a cage bar can be flowed around by the solder. If appropriate, the clearances for the short-circuiting bars are then made somewhat greater than the diameter of the bars themselves, so that solder can also penetrate axially through a remaining gap. Thus, a particularly good electrical connection is established between the cage bars and the short-circuiting ring.

The joining connections may advantageously run circumferentially. As a result, both a mechanical and electrically conducting connection is established to a sufficient degree. A joining connection that runs all the way around the circumference, i.e. along a slot, is also advantageous in the procedure that is followed by some joining methods.

In the case of an advantageous embodiment of the invention, the joining connections may be welded connections or soldered connections. Laser beam welding or electron beam welding is preferred for this. Such welded or soldered connections are particularly suitable in particular for joining connections running around the entire circumference. The weld bead thereby produced is produced within the slot that is present between the disks, and may if appropriate fill the slot completely as far as the disk outside face. In particular when additional solder material is introduced, the slot may be completely filled by a soldered connection. Both types of joining connection bring about good electrical conductivity in combination with mechanical strength.

In the case of an advantageous embodiment of the invention, the disks may have a thickness of 2 mm to 10 mm, preferably 3 to 6 mm. With this given disk thickness, a complete short-circuiting ring can be built up with approximately three to five disks. This means that the number of joining connections is correspondingly small, with the result that cost-effective production of the squirrel cage rotors is made possible. The disk thickness itself is chosen such that an individual component can be fabricated either by stamping or by other separating methods, for example from a strip material. In particular in the case of preferred thicknesses of between 3 and 6 mm, cost-effective production, on the basis of a strip material, is ensured. On the other hand, the disk thickness should be chosen to be as great as possible, in order to be able with few disks to build up a complete short-circuiting ring.

The disks may advantageously consist of a steel alloy or a copper alloy, in particular of a Cu—Cr—Zr, Cu—Ag or Al alloy. The respective choice of alloy is based on a balanced relationship of an electrical conductivity that is as good as possible combined with a sufficient tensile strength. The two alloys mentioned in the preferred choice meet these requirements. A further aspect in the choice of the types of alloy is also a susceptibility to corrosive attacks that is as low as possible.

In an advantageous configuration of the invention, the disks may have on the outer circumference two bevels or steps lying symmetrically in relation to one another. Bevels or steps lying symmetrically in relation to one another likewise bring about a symmetrically formed slot for the joining process in the joined-together state of multiple disks. The slot form and slot size are ultimately determined by the configuration of the bevels or steps on the disks. This means that a uniform bonding together of the two touching disks is realized in the joining process.

In the case of an advantageous embodiment of the invention, the cage bars may be prestressed radially toward the center. During operation, centrifugal forces that put an extreme load on the material are generated radially by a rapid rotation of the squirrel cage rotors. The cage bars prestressed radially toward the center counteract these centrifugal forces, with the result that the material loading drops significantly, in particular in the region of the short-circuiting rings. In this way it is also possible for materials that are primarily optimized for good electrical conductivity to be used for making the short-circuiting rings.

A short-circuiting ring may be advantageously at least partially enclosed by a housing. If a housing is used on the respective short-circuiting rings, it is necessary to adapt the dimensioning of the short-circuiting rings correspondingly. The housing is usually filled by the short-circuiting ring in such a way as to fill its volume. The outer contour of a housing is then usually also flush with the outer contour of a sheet stack. In particular, housings also serve the purpose of avoiding a corrosive attack on the alloy of the short-circuiting ring.

In the case of an advantageous embodiment of the invention, a clamping ring may be arranged as a housing around the circumference of a short-circuiting ring. This means that a property additional to the corrosion protection is used. Clamping rings that grip around the circumference of a short-circuiting ring are intended to compensate for radial forces that occur during the use of a squirrel cage rotor. Apart from the mechanically advantageous properties of a clamping ring, it may also be formed in such a way that it makes a contribution to the electrical conductivity of a short-circuiting ring. A suitable choice of material in this sense is firstly to optimize the clamping ring with respect to tensile strength and secondly to maintain sufficient electrical conductivity. In this way, the disks and clamping rings may also be made individually from quite different alloys that are optimized in terms of tensile strength and electrical conductivity.

Also preferably, a terminating cover may be arranged on the end face as a housing. A housing cover may also be made in such a way that an axial prestressing of the sheet stack arranged on the shaft and the respective disks is set by it. The prestressing serves the purpose of obtaining a compact structure in the process of joining the individual disks. Furthermore, terminating covers can in turn represent a certain protection from corrosion. A terminating cover may, however, also represent an end disk, in which the clearances only reach into the disk to a certain depth and do not pass right through it. Thus, one side of the disk is suitable for receiving the outermost ends of the cage bars. Whereas the other side of the disk is a planar surface, which terminates the short-circuiting ring at the end face. Such terminating covers may also have cooling ribs on the respective end faces.

A further aspect of the invention comprises a disk for a short-circuiting ring of a squirrel cage rotor according to the invention, in which the outside face has over the outer circumference at least one bevel or step, which extends radially into the region of the clearances in which the bar ends of cage bars can be arranged. The invention also comprises a short-circuiting ring of a squirrel cage rotor, which is built up from multiple disks according to the invention. This may involve the disks being fitted together in layers to form a disk stack and connected in advance, mechanically or with a material bond.

The connection may take place for example by stamping and stacking or by laser welding. In this way, a compact short-circuiting ring that can serve as a separate individual component and can be integrated particularly well in the overall system is obtained.

A further aspect of the invention comprises a method for producing a squirrel cage rotor according to the invention, wherein:
the laminated rotor core is arranged on the shaft,
short-circuiting rings, which are fitted together in layers from disks that are beveled around the outer circumference and have clearances to form a disk stack, are arranged on the shaft, the ends of the cage bars being able to extend out from the laminated rotor core through the clearances,
cage bars are arranged within the laminated rotor core and in the clearances in the disks,
a joining connection is established around the outer circumference in the region of the bevel or step.

In the case of an advantageous embodiment of the invention, before the joining connection is established, the disk stack and the laminated rotor core may be twisted together. The twisting of the assembly as a whole has the effect that the cage bars are turned by a certain angle out of the usual position parallel to the shaft. For this purpose, it is usually necessary to make somewhat larger clearances in the laminated core and disk stack, in order to make turning possible. The subsequent joining connection has the effect of stabilizing the structure as a whole. It is also considered to form the clearances in the laminated core and disk stack not perpendicularly to the respective main disk surface, but already at a turning angle. In this way, the passages are adapted to the turning angle, whereby easier twisting of the core is possible or predetermined.

Exemplary embodiments of the invention are explained in more detail on the basis of the schematic drawings, in which:

FIG. 1 schematically shows a side view of a squirrel cage rotor,

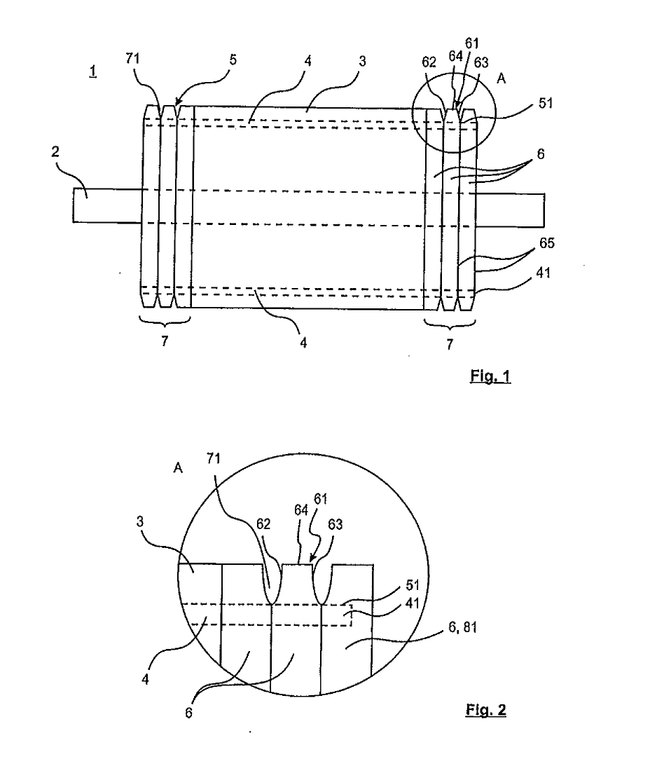

FIG. 2 shows a cutout of a detail from FIG. 1 in the region A of the short-circuiting rings,

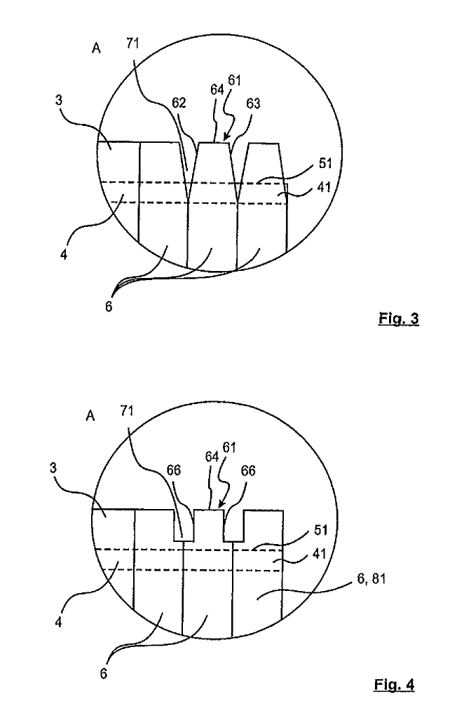

FIG. 3 shows a further view of a detail of the short-circuiting rings, and

FIG. 4 shows a further view of a detail of the short-circuiting rings.

Parts that correspond to one another are provided with the same designations in all of the figures.

FIG. 1 schematically shows a side view of a squirrel cage rotor 1. In this state, the laminated rotor core 3 has been positioned on the shaft 2, combined with two short-circuiting rings 5, which terminate the laminated rotor core 3 at the end faces. Multiple cage bars 4 are arranged within the laminated core 3 and the short-circuiting rings 5. The bar ends 41 of the cage bars 4 protrude into clearances 51 in the short-circuiting rings 5 and terminate flush with the last disk 6 of the disk stack 7. A disk stack 7 in this case consists of three disks 6, which have bevels 62, 63 in their outside faces 61, starting from the lateral surface 64. The slots 71 that are formed between the two bevels 62, 63 of two neighboring disks 6 serve as a joining gap of the short-circuiting rings 5. In this case, the first bevel 62 and the neighboring second bevel 63 are configured in a planar and symmetrical manner, with the result that a V-shaped slot is produced between two disks 6. Seen radially, the V-shaped slot reaches as far as the clearance 51, into which the cage bars 4 are introduced. The respective bottom and top faces of the disks 6 lie flush against one another. In FIG. 1, no joining connection, for example by welding or soldering, has been realized as yet in the joining gap.

FIG. 2 shows a cutout of a detail from FIG. 1 in the region A of the short-circuiting rings. In this case, a slot 71 that is formed by parabolic bevels 62 and 63 is configured. Also in this case, the slot 71 reaches as far as the depth of the clearance 51 for a cage bar 4. The sheet stack 3 terminates flush with the outside face 61, and consequently the lateral surface 64, of the respective disks 6. In particular in the case of joining by laser, such slot forms are of particular advantage. The slot form ultimately assists the guidance of a laser beam as far as the depth in the region of the cage bar 4 in which the joining connection is ultimately to be established. The slot depths represented in FIG. 1 and FIG. 2, on the basis of the respective beveled disks 6, are consequently suitable primarily for laser beam joining. Moreover, the end disk 6 is made as a terminating cover 81, in that a clearance that does not pass all the way through receives the outermost end 41 of a cage bar 4. The detail also does not show as yet a joining connection.

FIG. 3 shows a further view of a detail A of the short-circuiting rings, which are connected in particular by hard soldering or welding as joining methods. In this case, the bars 4 extend out from the sheet stack 3 in such a way that they are still partly exposed in the region of the slot 71 that is formed by the first bevel 62 and the second bevel 63. The clearances 51 are consequently still positioned in the region of the beveled disks. During the subsequent joining, the exposed regions of the bars in a slot are flowed around by the hard solder or by a melt produced by means of a laser beam or electron beam and are connected in an electrically conducting manner to the disks 6.

FIG. 4 shows a further view of a detail A of the short-circuiting rings, which are connected in particular by welding as the joining method. In this case, the bars 4 extend out from the sheet stack 3 in such a way that they are no longer exposed in the region of the slot 71 that is formed by the steps 66. The clearances 51 are consequently positioned somewhat within the step of the disks and nevertheless lie in the region of the melting zone. During the subsequent joining, the regions of the bars in the vicinity of a slot are nevertheless flowed around by a melt produced by means of a laser beam or electron beam and are connected in an electrically conducting manner to the disks 6. The melt bath thereby produced is not yet shown in FIG. 4.

### LIST OF DESIGNATIONS

1 Squirrel cage rotor
2 Shaft
3 Laminated rotor core
4 Cage bar
41 Bar end
5 Short-circuiting ring
51 Clearance
6 Disk
61 Outside face
62 First bevel
63 Second bevel
64 Lateral surface
65 Bottom or top face
66 Step
7 Disk stack
71 Slot
8 Housing
81 Terminating cover
A Cutout showing a detail

1. Squirrel cage rotor (1), in particular for an asynchronous machine, with a shaft (2), a laminated rotor core (3) with cage bars (4) and short-circuiting rings (5) arranged within it, at least part of a short-circuiting ring (5) consisting of a disk stack (7), which is built up in layers from disks (6) with clearances (51), through which the ends of the cage bars (4) extend out from the laminated rotor core (3),
characterized
in that the disks (6) of a short-circuiting ring (5) have, starting from the lateral surface (64) as the outside face (61), over the outer circumference at least one bevel (62, 63) or step (66), which is directed radially inward, and
in that, by their respective bevels (62, 63) or steps (66), neighboring disks (6) form in the disk stack (7) a slot (71), in which there is a joining connection, at least in certain portions.

2. Squirrel cage rotor (1) according to claim 1, characterized in that the bar ends (41) are joined in an electrically conducting manner to the disk stack (7) of a short-circuiting ring (5).

3. Squirrel cage rotor (1) according to claim 2, characterized in that the joining connections run circumferentially.

4. Squirrel cage rotor (1) according to claim 2, characterized in that the joining connections are welded connections or soldered connections.

5. Squirrel cage rotor (1) according to claim 1, characterized in that the disks (6) have a thickness of 2 mm to 10 mm, preferably 3 to 6 mm.

6. Squirrel cage rotor (1) according to claim 1, characterized in that the disks (6) consist of a steel alloy or a copper alloy, in particular of a Cu—Cr—Zr, Cu—Ag or Al alloy.

7. Squirrel cage rotor (1) according to claim 1, characterized in that the disks (6) have on the outer circumference two bevels (62, 63) or steps (66) lying symmetrically in relation to one another.

8. Squirrel cage rotor (1) according to claim 1, characterized in that the cage bars (4) are prestressed radially toward the center.

9. Squirrel cage rotor (1) according to claim 1, characterized in that a short-circuiting ring (5) is at least partially enclosed by a housing (8).

10. Squirrel cage rotor (1) according to claim 9, characterized in that a clamping ring is arranged as a housing (8) around the circumference of a short-circuiting ring (5).

11. Squirrel cage rotor (1) according to claim 9, characterized in that a terminating cover (81) is arranged on the end face as a housing (8).

12. Disk for a short-circuiting ring (5) of a squirrel cage rotor (1) according to claim 1, characterized in that the outside face (61) has over the outer circumference at least one bevel (62, 63) or step (66), which extends radially into the region of clearances (51), in which the bar ends (41) of cage bars (4) can be arranged.

13. Short-circuiting ring (5) of a squirrel cage rotor, built up from multiple disks according to claim 12,

14. Method for producing a squirrel cage rotor (1) according to claim 1, characterized
in that the laminated rotor core (3) is arranged on the shaft (2),
in that short-circuiting rings (5), which are fitted together in layers from disks (6) that are beveled around the outer circumference and have clearances (51) to form a disk stack (7), are arranged on the shaft (2), the ends of the cage bars (4) being able to extend out from the laminated rotor core (3) through the clearances,
in that cage bars (4) are arranged within the laminated rotor core (3) and in the clearances (51) in the disks (6),
in that a joining connection is established around the outer circumference in the region of the bevel or step.

15. Method according to claim 14, characterized in that, before the joining connection is established, the disk stack (7) and the laminated rotor core (3) are twisted together.
